(19) United States
(12) Patent Application Publication
(10) Pub. No.: US 2007/0179250 A1
(43) Pub. Date: Aug. 2, 2007

(54) Laminating resin with reduced styrene monomer

(75) Inventors: Lianzhou Chen, Raleigh, NC (US); Hildeberto Nava, Cary, NC (US)

Correspondence Address: MYERS BIGEL SIBLEY & SAJOVEC, PO BOX 37428, RALEIGH, NC, 27627, US

(73) Assignee: Reichhold, Inc.

(21) Appl. No.: 11/342,950

(22) Filed: Jan. 30, 2006

(51) Int. Cl. C08L 67/02; C08L 75/04

(52) U.S. Cl. 525/316; 525/445; 525/455; 525/302

(57) ABSTRACT

A laminating resin having low styrene content is provided. The resin includes a thermosetting resin and a reactive intermediate including a low molecular weight polyester oligomer endcapped with at least one (meth)acrylic acid, its ester or its anhydride thereof.

### FIELD OF THE INVENTION

The present invention relates to laminating resins, and particularly laminating resins having low or no styrene content.

### BACKGROUND OF THE INVENTION

Reduction of styrene emissions remains a key issue in open mold processes using styrene-containing materials such as unsaturated polyesters, vinyl esters and other thermosetting resins. One of the largest areas of application is the open molding process, particularly hand lay-up, spray-up, non-reinforced castings, gelcoats and filament winding. New environmental concerns demand a better control on the emissions of organic compounds into the environment. This is prompting industry to find ways to develop technologies that can provide less potential hazards to workers in contact with thermosetting resins. At the same time, the market requires that those new products should have minimal increase in cost when commercialized and do not compromise reactivity of the resins. Important is that all materials should also have good compatibility with all components in the mixtures, viscosities should stay within an acceptable range so that pouring or spraying is not compromised. In addition, wetting of glass or fillers also need to be maintained and physical properties should be similar or better than the standard materials currently in use.

Several methods have been proposed as possible ways to reduce styrene to minimize monomer emissions during the curing process of unsaturated polyesters and vinyl esters. One common method is the replacement of styrene by another reactive diluent that can produce fewer emissions during curing. This approach can lead to systems with slower reactivity, incomplete curing and higher costs. Reducing the amount of styrene or reactive diluent has been used as an attempt to reduce emissions. However, this approach leads to higher viscosities, making more difficult for hand lay-up, rolling or spraying of the resins.

Another approach involves the preparation of low molecular weight polymers. Polymers with lower molecular weight are more soluble in styrene or other reactive diluent yielding lower viscosities and therefore requiring lower amounts diluents. Problems associated with low molecular weight thermosetting systems are that the resulting physical properties of the final products are highly compromised. Overall, products have inferior performance comparing to those of higher molecular weight components.

Another common approach also used in the reduction of styrene emissions is adding waxes to the thermosetting resins. Waxes limit the elimination of diluent vapors during the curing, however, problems encountered with this approach is the poor interlaminate bonding.

An additional inherent problem with unsaturated polyesters is their shrinkage. Shrinkage with thermosetting resin systems can be as high as 5 percent or even more, depending on the reactivity of the unsaturated polyester and the structure and the level of crosslinking monomer. Shrinkage usually occurs during the curing process and can affect the dimensional stability by warping the finished parts. It is desirable to reduce the shrinkage and improve the surface appearance of the molded articles. This problem can be alleviated by the addition of an appropriate low profile additive such as a thermoplastic. The challenge however, is to find the appropriate resin composition that can have the right compatibility and good shrink control with systems containing low amounts of styrene or other reactive diluents.

Prior art describing these approaches include, for example, U.S. Pat. Nos. 5,874,503 and 4,546,142 which describe the use of waxes with a variety of unsaturated polyester resins. The wax is pre-dispersed in the resin and during the curing process, the wax forms a thin film on the surface of the laminates prepared. The thin films of wax act as a barrier preventing styrene from evaporating at the moment of curing the laminates. A disadvantage on using waxes is that the wax separates from the resin when the resin mixture is exposed to cold temperatures, becoming inefficient at the time of curing the composites.

U.S. Pat. Nos. 5,393,830; 5,492,668 and 5,501,830 to Smeal et al. proposed laminating resins which employs a reduce amounts of styrene so as to meet a specified volatile emission level according to test standards. The resin mixtures described include polyester resin, ethylene glycol dimethacrylate, vinyl toluene, cyclohexyl methacrylate, and bisphenol A dimethacrylate. The compositions require diluents with high cost and have more difficulty in wetting fibers.

U.S. Pat. No. 6,468,662 to Nava, describes his approach using a low molecular weight epoxy acrylate in combination with reduced amount of styrene and methacrylate monomers. Glass fiber wetting is improved but cost is compromised in certain applications.

U.S. Pat. Nos. 5,118,783; 6,107,446 and U.S. Patent Application No. 2004/068088, describe the preparation of unsaturated polyesters with low molecular weight. The intermediates are prepared by using monohydric alcohols to control the low molecular weight. As stated above, resin with low molecular weight and low styrene content can compromise physical properties of the resulting cured materials.

Other approaches to control the molecular weight of polyesters and add reactivity to the molecules are by end-capping the polymers with unsaturated monomers. U.S. Pat. Nos. 5,096,938 and 6,150,458 describe end-capping of polyester polyols with (meth)acrylic acid or their alkyl esters. A different approach is proposed in U.S. Pat. Nos. 5,373,058 and 5,747,607, where glycidyl methacrylate is used to react with polyesters containing acid end groups.

Riley et al. described in U.S. Patent Application No. 2004/00776830 A1, the preparation of saturated polyester polyols prepared from trans-esterification of a high molecular weight polyethylene terephthalate with small amounts of dihydric alcohols. The resulting lower molecular weight polyol is then end-capped with methacrylic acid or its anhydride. The resulting intermediates are of high viscosities and limit their applicability in spray-up, hand lay-up or as blending resins with other thermosetting resins.

Thus it would be desirable to provide a laminating resin with a low vinyl aromatic or styrene content.

### SUMMARY OF THE INVENTION

The present invention provides a laminating resin having a low styrene or other vinyl aromatic content, and which exhibits improved physical properties and low shrinkage. In one embodiment, the laminating resin comprises a thermosetting resin and a reactive intermediate comprising a low molecular weight polyester oligomer endcapped with at least one (meth)acrylic acid, its ester or its anhydride. The reactive intermediate is formed by esterifying or trans-esterifying a saturated or unsaturated polyester and further esterifying or trans-esterifying with at least one polyhydric alcohol. Suitable thermosetting resins include saturated or unsaturated polyesters, urethanes and vinyl esters.

The invention also relates to an article of manufacture. The article of manufacture comprises a substrate comprising reinforcing fibrous materials and a laminating resin coated onto the substrate.

### DETAILED DESCRIPTION OF THE PREFERRED EMBODIMENTS

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do hot preclude the presence or addition of one or more other features, integers, steps, operations, elements, components, and/or groups thereof. The patent references cited throughout the specification are incorporated by reference in their entireties.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined therein. For the purpose of the invention, the term “laminating resin” is to be broadly interpreted to include any resin which may be applied as a spray, rolled, brushed or coated onto a suitable substrate.

As described above, the present invention provides a laminating resin having a low styrene or a low other vinyl aromatic content. Such a laminating resin, in addition to having substantially reduced or being derived of styrene has improved physical properties and low shrinkage.

In general, the laminating resin comprises:
a) a thermosetting resin (1-99 percent by weight);
b) a reactive intermediate comprising a low molecular weight polyester oligomer endcapped with at least one (meth)acrylic acid, its ester or its anhydride (1-99 percent by weight);
c) optionally a filler (0-60 percent by weight);
d) optionally a polyfunctional acrylate (0-40 percent by weight);
e) optionally a low profile additive (0-50 percent by weight); and
f) optionally a vinyl aromatic monomer (0-40 percent by weight).

The reactive intermediate often has a viscosity of 150 to 250 cps. The reactive intermediate can be formed by esterifying or trans-esterifying a saturated or unsaturated polyester followed by further esterifying or trans-esterifying with a polyhydric alcohol. The ratio of saturated or unsaturated polyester to polyhydric alcohol is often 1:1.2 to 1:1.5. The esterification or trans-esterification is performed at temperatures from about 150° C. to about 250° C. and at a pressure from about standard pressure to about 200 psi. As is used herein and in the claims, by “(meth)acrylate” and the like terms is meant both (meth)acrylates and acrylates. Without intending any limitation, examples for the preparation of the polymers are described, for example, in WO 01/27183; U.S. Patent Application No. 2004/0076830; U.S. Pat. Nos. 6,153,788, 5,821,383; and 4,675,433

### Unsaturated Polyesters

In an embodiment, the reactive intermediates undergo crosslinking reactions with thermosetting resins or in the presence of thermoplastic resins or their mixtures to form the laminating resin. For the purpose of the invention, unsaturated polyester resins, saturated polyester resins and vinyl ester resins are preferably employed. A polyester resin may be formed from conventional methods. Typically, the resin is formed from the reaction between a polyfunctional organic acid or anhydride and a polyhydric alcohol under conditions known in the art. The polyfunctional organic acid or anhydride which may be employed are any of the numerous and known compounds. Suitable polyfunctional acids or anhydrides thereof include, but are not limited to, maleic acid, fumaric acid, citraconic acid, itaconic acid, glutaconic acid, phthalic acid, isophthalic acid, terephthalic acid, tetrahydrophthalic anhydride, cyclohexane dicarboxylic acid, succinic anhydride, adipic acid, sebacic acid, azelaic acid, malonic acid, alkenyl succinic acids such as n-dodecenyl succinic acid, dodecylsuccinic acid, octadecenyl succinic acid, and anhydrides thereof. Lower alkyl esters of any of the above may also be employed. Mixtures of any of the above are suitable, without limitation intended by this.

Additionally, polybasic acids or anhydrides thereof having not less than three carboxylic acid groups may be employed. Such compounds include 1,2,4-benzenetricarboxylic acid, 1,3,5-benzene tricarboxylic acid, 1,2,4-cyclohexane tricarboxylic acid, 2,5,7-naphthalene tricarboxylic acid, 1,2,4-naphthalene tricarboxylic acid, 1,3,4-butane tricarboxylic acid, 1,2,5-hexane tricarboxylic acid, 1,3-dicarboxyl-2-methyl-2-carboxymethylpropane, tetra(carboxymethyl)methane, 1,2,7,8-octane tetracarboxylic acid, and mixtures thereof.

Suitable polyhydric alcohols which may be used in forming the saturated or unsaturated polyester resins include, but are not limited to, ethylene glycol, diethylene glycol, propylene glycol, dipropylene glycol, 1,3-butanediol, 1,4-butanediol, 1,3-hexanediol, neopentyl glycol, 2-methyl-1,3-propanediol, 1,3-butylene glycol, 1,6-hexanediol, hydrogenated bisphenol A, cyclohexane dimethanol, 1,4-cyclohexanol, ethylene oxide adducts of bisphenols, propylene oxide adducts of bisphenols, sorbitol, 1,2,3,6-hexatetrol, 1,4-sorbitan, pentaerythritol, dipentaerythritol, tripentaerythritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene. Mixtures of any of the above alcohols may be used.

DCPD resins used in the composition of the invention are known to those skilled in the art. These resins are typically DCPD polyester resins and derivatives which may be made according to various accepted procedures. As an example, these resins may be made by reacting DCPD, ethylenically unsaturated dicarboxylic acids, and compounds having two groups wherein each contains a reactive hydrogen atom that is reactive with carboxylic acid groups. DCPD resins made from DCPD, maleic anhydride, phthalic anhydride, isophthalic acid, terephthalic acid, adipic acid, water, and a glycol such as, but not limited to, ethylene glycol, propylene glycol, diethylene glycol, neopentyl glycol, dipropylene glycol, and poly-tetramethylene glycol, are particularly preferred for the purposes of the invention. The DCPD resin may also include nadic acid ester segments that may be prepared in-situ from the reaction of pentadiene and maleic anhydride or added in its anhydride form during the preparation of the polyester. Examples on the preparation of DCPD unsaturated polyester resins can be found in U.S. Pat. No. 3,883,612.

The unsaturated polyester resin may be used in various amounts in the laminating resin composition of the invention. Preferably, the laminating resin composition comprises from about 5 to about 80 weight percent of unsaturated polyester resin, and more preferably from about 20 to about 40 weight percent. Preferably, the unsaturated polyester resin has a number average molecular weight ranging from about 700 to about 5,000, and more preferably from about 800 to about 3,000. Additionally, the unsaturated polyester resin preferably has an ethylenically unsaturated monomer content of below 50 percent at an application viscosity of 200 to 3000 cps.

### Vinyl Esters

The vinyl ester resins employed in the invention include the reaction product of an unsaturated monocarboxylic acid or anhydride with an epoxy resin. Exemplary acids and anhydrides include (meth)acrylic acid or anhydride, α-phenylacrylic acid, α-chloroacrylic acid, crotonic acid, mono-methyl and mono-ethyl esters of maleic acid or fumaric acid, vinyl acetic acid, sorbic acid, cinnamic acid, and the like, along with mixtures thereof. Epoxy resins which may be employed are known and include virtually any reaction product of a polyfunctional halohydrin, such as epichlorohydrin, with a phenol or polyhydric phenol. Suitable phenols or polyhydric phenols include, for example, resorcinol, tetraphenol ethane, and various bisphenols such as Bisphenol “A”, 4,4′-dihydroxydiphenyl sulfone, 4,4′-dihydrohy biphenyl, 4,4′-dihydroxydiphenyl methane, 2,2′-dihydoxydiphenyloxide, and the like. Novolac epoxy resins may also be used. Mixtures of any of the above may be used. Additionally, the vinyl ester resins may have pendant carboxyl groups formed from the reaction of esters and anhydrides and the hydroxyl groups of the vinyl ester backbone.

Other components in the resin mixture may include epoxy acrylate oligomers known to those who are skilled in the art. As an example, the term “epoxy acrylates oligomer” may be defined for the purposes of the invention as a reaction product of acrylic acid and/or methacrylic acid with an epoxy resin. Examples of processes involving the making of epoxy acrylates can be found in U.S. Pat. No. 3,179,623, the disclosure of which is incorporated herein by reference in its entirety. Epoxy resins that may be employed are known and include virtually any reaction product of a polyfunctional halohydrin, such as, but not limited to, epichlorohydrin, with a phenol or polyhydric phenol. Examples of phenols or polyhydric phenols include, but are not limited to, resorcinol, tetraphenol ethane, and various bisphenols such as Bisphenol-A, 4,4′-dihydroxy biphenyl, 4,4′-dihydroxydiphenylmethane, 2,2′-dihydroxydiphenyloxide, phenol or cresol formaldehyde condensates and the like. Mixtures of any of the above can be used. The preferred epoxy resins employed in forming the epoxy acrylates are those derived from bisphenol A, bisphenol F, especially preferred are their liquid condensates with epichlorohydrin having a molecular weight preferably in the range of from about 800 to about 5000. The preferred epoxy acrylates that are employed of the general formula: 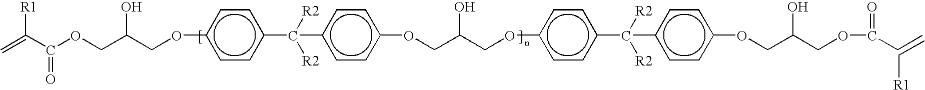
where R1 and R2 is H or CH₃ and n ranges from 0 to 100, more preferably from 0 to 50.

Other examples of epoxy acrylate oligomers that may be used include comparatively low viscosity epoxy acrylates. As an example, these materials can be obtained by reaction of epichlorohydrin with the diglycidyl ether of an aliphatic diol or polyol.

### Polyurethane Acrylates

Polyacrylates are also useful in the present invention for the preparation of the molding compositions. A urethane poly(acrylate) characterized by the following empirical formula may used as part of the mixtures: 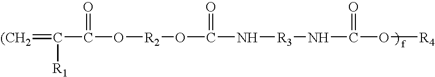
wherein R₁ is hydrogen or methyl; R₂ is a linear or branched divalent alkylene or oxyalkylene radical having from 2 to 5 carbon atoms; R₃ is a divalent radical remaining after reaction of a substituted or unsubstituted diisocyanate; R₄ is a residue containing hydroxyl group or a hydroxyl free residue of an organic polyhydric alcohol which contained hydroxyl groups bonded to different atoms; and f has an average value of from 2 to 4. The compounds are typically the reaction products of polyols in which the hydroxyl groups are first reacted with a diisocyanate using one equivalent of diisocyanate per hydroxyl group, and the free isocyanate groups are the reacted with a hydroxyalkyl ester of acrylic or methacrylic acid.

The polyhydric alcohol suitable for preparing the urethane poly(acrylate) typically contains at least two carbon atoms and may contain from 2 to 4, inclusive, hydroxyl groups. Polyols based on the polycaprolactone ester of a polyhydric alcohol such as described in, for example U.S. Pat. No. 3,169,945 is included. Unsaturated polyols may also be used such as those described in U.S. Pat. Nos. 3,929,929 and 4,182,830.

Diisocyanates suitable for preparing the urethane poly(acrylate) are well known in the art and include aromatic, aliphatic, and cycloaliphatic diisocyanates. Such isocyanates may be extended with small amounts of glycols to lower their melting point and provide a liquid isocyanate. The hydroxyalkyl esters suitable for final reaction with the polyisocyanate formed from the polyol and diisocyanate are exemplified by hydroxylacrylate, hydroxypropyl acrylate, hydroxyethyl methacrylate, and hydroxypropyl methacrylate. Any acrylate or methacrylate ester or amide containing an isocyanate reactive group may be used herein, however.

Urethane poly(acrylates) such as the above are described in for example, U.S. Pat. Nos. 3,700,643; 4,131,602; 4,213,837; 3,772,404 and 4,777,209.

A urethane poly(acrylate) characterized by the following empirical formula: 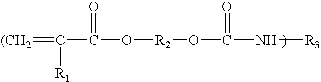
where R₁ is hydrogen or methyl; R₂ is a linear or branched alkylene or oxyalkylene radical having from 2 to about 6 carbon atoms; R₃ is the polyvalent residue remaining after the reaction of a substituted or unsubstituted polyisocyanate; and g has an average value of from about 2 to 4. These compounds are typically the reaction products of a polyisocyanate with a hydroxyalkyl ester per isocyanate group.

Polyisocyanates suitable for preparing the urethane poly(acrylates) are well known in the art and include aromatic, aliphatic and cycloaliphatic polyisocyanates. Some diisocyanates may be extended with small amounts of glycol to lower their melting point and provide a liquid isocyanate.

Urethanes poly(acrylates) such as the above are described in, for example U.S. Pat. No. 3,297,745 and British Patent No. 1,159,552.

A half-ester or half-amide characterized by the following formula: 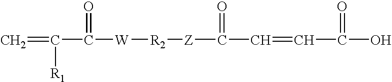
wherein R₁ is hydrogen or methyl. R₂ is an aliphatic or aromatic radical containing from 2 to about 20 carbon atoms, optionally containing —O— or 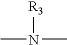
W and Z are independently —O— or 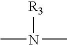
And R₃ is hydrogen or low alkyl. Such compounds are typically the half-ester or half-amide product formed by the reaction of a hydroxyl, amino, or alkylamino containing ester or amide derivatives of acrylic or methacrylic acid with maleic anhydride, maleic acid, or fumaric acid. These are described in, for example, U.S. Pat. Nos. 3,150,118 and 3,367,992.

### Isocyanurate Acrylates

An unsaturated isocyanurate characterized by the following empirical formula: 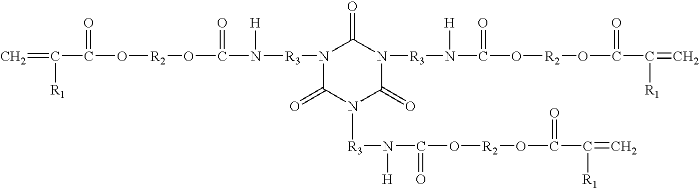
wherein R₁ is a hydrogen or methyl, R₂ is a linear or branched alkylene or oxyalkylene radical having from 2 to 6 carbon atoms, and R₃ is a divalent radical remaining after reaction of a substituted or unsubstituted diisocyanate. Such products are typically produced by the reaction of a diisocyanate reacted with one equivalent of a hydroxyalkyl ester of acrylic or methacrylic acid followed by the trimerization reaction of the remaining free isocyanate.

It is understood that during the formation of the isocyanurate, a diisocyanate may participate in the formation of two isocyanurate rings thereby forming crosslinked structures in which the isocyanurate rings may be linked by the diisocyanate used. Polyiisocyanates might also be used to increase this type of crosslink formation.

Diisocyanates suitable for preparing the urethane poly(acrylate) are well known in the art and include aromatic, aliphatic, and cycloaliphatic diisocyanates. Such isocyanates may be extended with small amounts of glycols to lower their melting point and provide a liquid isocyanate.

The hydroxyalkyl esters suitable for final reaction with the polyisocyanate formed from the polyol and diisocyanate are exemplified by hydroxylacrylate, hydroxypropyl acrylate, hydroxyethyl methacrylate, and hydroxypropyl methacrylate. Any acrylate or methacrylate ester or amide containing an isocyanate reactive group may be used herein, however. Other alcohols containing one hydroxyl group may also be used. The monoalcohols may be monomeric or polymeric.

Such unsaturated isocyanurates are described in, for example, U.S. Pat. No. 4,195,146.

### Polyamide Ester Acrylates

Poly(amide-esters) as characterized by the following empirical formula: 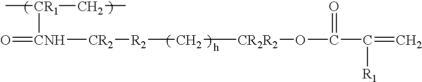
wherein R₁ is independently hydrogen or methyl, R₂ is independently hydrogen or lower alkyl, and h is 0 or 1. These compounds are typically the reaction product of a vinyl addition prepolymer having a plurality of pendant oxazoline or 5,6-dihydro-4H-1,3-oxazine groups with acrylic or methacrylic acid. Such poly(amide-esters) are described in, for example, British Patent No. 1,490,308.

A poly(acrylamide) or poly(acrylate-acrylamide) characterized by the following empirical formula: 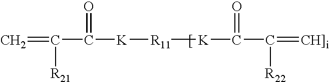
wherein R₁ is the polyvalent residue of an organic polyhydric amine or polyhydric aminoalcohol which contained primary or secondary amino groups bonded to different carbon atoms or, in the case of an aminoalcohol, amine and alcohol groups bonded to different carbon atoms; R₂ and R₃ are independently hydrogen or methyl; K is independently —O— or 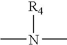
R₄ is hydrogen or lower alkyl; and i is 1 to 3.

The polyhydric amines suitable for preparing the poly(acrylamide) contains at least two carbon atoms and may contain 2 to 4, inclusive, amine or alcohol groups, with the proviso that at least one group is a primary or a secondary amine. These include alkane aminoalcohols and aromatic containing aminoalcohols. Also included are polyhydric aminoalcohols containing ether, amino, amide, and ester groups in the organic residue.

Examples of the above compounds are described, in for example, Japanese Publications Nos. JP80030502, JP80030503, and JP800330504 and U.S. Pat. No. 3,470,079 and British Patent No. 905,186.

It is understood by those skilled in the art that the thermosetable organic materials described, supra, are only representative of those which may be used in the practice of this invention.

### Saturated Polyesters and Urethanes

Saturated polyester and polyurethanes that may also be used in this invention include, for example, those described in U.S. Pat. Nos. 4,871,811, 3,427,346 and 4,760,111. The saturated polyester resins and polyurethanes are particularly useful in hand lay-up, spray up, sheet molding compounding, hot melt adhesives and pressure sensitive adhesives applications. Appropriate saturated polyester resins include, but are not limited to, crystalline and amorphous resins. The resins may be formed by any suitable technique. For example, the saturated polyester resin may be formed by the polycondensation of an aromatic or aliphatic di- or polycarboxylic acid and an aliphatic or alicyclic di- or polyol or its prepolymer. Optionally, either the polyols may be added in an excess to obtain hydroxyl end groups or the dicarboxylic monomers may be added in an excess to obtain carboxylic end groups. Suitable polyurethane resins may be formed by the reaction of diols or polyols as those described in U.S. Pat. No. 4,760,111 and diisocyanates. The diols are added in an excess to obtain hydroxyl terminal groups at the chain ends of the polyurethane. The saturated polyesters and polyurethanes may also contain other various components such as, for example, an ethylene-vinyl acetate copolymer, an ethylene-ethyl acrylate copolymer, and the like.

### Thermoplastic Polymers—Low Profile Agents

Thermoplastic polymeric materials which reduce shrinkage during molding are also included in the composition of the invention. These thermoplastic materials can be used to produce molded articles having surfaces of improved smoothness. The thermoplastic resin is added into the unsaturated polyester composition according to the invention in order to suppress shrinkage at the time of curing. The thermoplastic resin is provided in a liquid form and is prepared in such a manner that 30 to 70% by weight of the thermoplastic resin is dissolved in 30 to 70% by weight of a polymerizable monomer. Examples of the thermoplastic resin may include styrene-base polymers, polyethylene, polyvinyl acetate base polymer, polyvinyl chloride polymers, polyethyl methacrylate, polymethyl methacrylate or copolymers, ABS copolymers, Hydrogenated ABS, polycaprolactone, polyurethanes, butadiene styrene copolymer, and saturated polyester resins. Additional examples of thermoplastics are copolymers of: vinyl chloride and vinyl acetate; vinyl acetate and acrylic acid or methacrylic acid; styrene and acrylonitrile; styrene-acrylic acid and allyl acrylates or methacrylates; methyl methacrylate and alkyl ester of acrylic acid; methyl methacrylate and styrene; methyl methacrylate and acrylamide. In the resin composition according to the invention, 5 to 50% by weight of the liquid thermoplastic resin is mixed; preferably 10 to 30% by weight of the liquid thermoplastic resin is mixed.

Low profile agents (LPA) are composed primarily of thermoplastic polymeric materials. These thermoplastic intermediates present some problems remaining compatible with almost all types of thermosetting resin systems. The incompatibility between the polymeric materials introduces processing difficulties due to the poor homogeneity between the resins. Problems encountered due to phase separation in the resin mixture include, scumming, poor color uniformity, low surface smoothness and low gloss. It is therefore important to incorporate components that will help on stabilizing the resin mixture to obtain homogeneous systems that will not separate during and after their preparation. For this purpose, a variety of stabilizers can be used in the present invention which includes block copolymers from polystyrene-polyethylene oxide as those described in U.S. Pat. Nos. 3,836,600 and 3,947,422. Block copolymer stabilizers made from styrene and a half ester of maleic anhydride containing polyethylene oxide as described in U.S. Pat. No. 3,947,422. Also useful stabilizers are saturated polyesters prepared from hexanediol, adipic acid and polyethylene oxide available from BYK Chemie under code number W-972. Other type of stabilizers may also include addition type polymers prepared from vinyl acetate block copolymer and a saturated polyester as described in Japanese Unexamined Patent application No. Hei 3-174424.

### Reactive Ethylenically Unsaturated Moieties

In the present invention, any radically polymerizable alkene can serve as a dilution monomer for the resins. However, co-monomers that correspond to the following formula are especially suitable for polymerization in accordance with the invention: 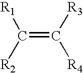
where R₁ and R₂ are independently selected from the group consisting of H, halogen, CN, straight or branched alkyl of from 1 to 20 carbon atoms, preferably 1 to 6 and specially preferably 1 to 4 carbon atoms, which can be substituted with 1 to (2n+1) halogen atoms where n is the number of carbon atoms of the alkyl group (for example CF₃), α,β-unsubstituted straight or branched alkenyl or alkynyl groups with 2 to 10 carbon atoms, preferably 2 to 6 and specially preferably 2 to 4 carbon atoms which can be substituted with 1 to (2n−1) halogen atoms where n is the number of carbon atoms of the alkyl group, α,β-unsaturated straight or branched of 2 to 6 carbon atoms (preferably vinyl) substituted (preferably at the α-position) with a halogen (preferably chlorine), C₃-C₈ cycloalkyl, heterocyclyl, C(═Y) R₅, C(═Y)NR₆R₇, YC(═Y)R₅, SOR₅, SO₂R₅, OSO₂R₅, NR₈SO₂R₅, PR₅², P(═Y)R₅², YPR₅², YP(═Y) R₅², NR₈², which can be quaternized with an additional R₈, aryl, or heterocyclyl group, where Y may be NR₈, S or O, preferable O; R₅ is alkyl of from 1 to 20 carbon atoms, an alkylthio group with 1 to 20 carbon atoms, OR₁₅ (OR₁₅ is hydrogen or an alkyl metal), alkoxy of from 1 to 20 carbon atoms, aryloxy or heterocyclyloxy; R₆ and R₇ are independently H or Alkyl of from 1 to 20 carbon atoms, or R₆ and R₇ may be joined together to form an alkylene group of from 2 to 7 carbon atoms, preferably 2 to 5 carbon atoms, where they form a 3- to 8-member ring, preferably 3 to 6 member ring, and R₈is H, straight or branched C₁-C₂₀ alkyl or aryl; and R₃ and R₄ are independently selected from the group consisting of H, halogen (preferably chlorine or fluorine), C₁-C₆ alkyl or COOR₉, where R₉ is H, an alkyl metal, or a C₁-C₄₀ alkyl group; or R₁ and R₃ can together form a group of the formula (CH₂)n; which can be substituted with 1 to 2n halogen atoms or a group of the formula C(═O)—Y—C(═O), where n is from 2 to 6, preferably 3 to 4, and Y is defined as before; and where at least two of R₁, R₂, R₃ and R₄ are H or methyl group.

Furthermore in the present application, “aryl” refers to phenyl, naphthyl, phenanthryl, anthracenyl, phenalenyl, triphenylenyl, fluoranthrenyl, pyrenyl, pentacenyl, chrycenyl, naphthacenyl, hexaphenyl, picenyl and perynelenyl (preferably phenyl and naphthyl), in which each hydrogen atom may be replaced with alkyl of from 1 to 20 carbon atoms (preferably from 1 to 6 carbon atoms and more preferably methyl) alkyl of from 1 to 20 carbon atoms (preferably from 1 to 6 carbon atoms and more preferably methyl) in which each of the hydrogen atoms is independently replaced by a halide (preferably a fluoride or a chloride), alkenyl of from 2 to 20 carbon atoms, alkynyl of from 1 to 20 carbon atoms, alkoxy from 1 to 6 carbon atoms, alkylthio of from 1 to 6 carbon atoms, C₃ -C₈ cycloalkyl, phenyl, halogen, NH₂, C₁-C₆-alkylamino, C₁-C₆ dialkylamino, and phenyl which may be substituted with the from 1 to 5 halogen atoms and/or C₁-C₄ alkyl groups. (This definition of “aryl” also applies to the aryl groups in “aryloxy” and “aralkyl”). Thus phenyl may be substituted from 1 to 5 times and naphthyl may be substituted from 1 to 7 times (preferably, any aryl group, if substituted, is substituted from 1 to 3 times) with one of the above substituents. More preferably, “aryl” refers to phenyl, naphthyl, phenyl substituted from 1 to 5 times with fluorine or chlorine, and phenyl substituted from 1 to 3 times with a substituent selected from the group selected from the group consisting of alkyl of from 1 to 6 carbon atoms, alkoxy of from 1 to 4 carbon atoms and phenyl. Most preferably, “aryl” refers to phenyl, tolyl and methoxyphenyl.

In the context of the present invention, “heterocyclyl” refers to pyrydyl furyl, pyrrolyl, furyl, pyrrolyl, thienyl, imidazolyl, pyrazolyl, pyrazinyl, pyridiminyl, pyridazinyl, pyranyl, indonyl, isoindonyl, indazolyl, benzofuryl, isobenzofuryl, benzothienyl, isobenzothienyl, chromenyl, xanthenyl, purinyl, pteridinyl, quinolyl, isoquinolyl, phthalazinyl, quinazolinyl, quinoxalinyl, naphthyridinyl, phenoxathiinyl, carbazolyl, cinnolinyl, phenanthridinyl, acridinyl, 1,10-phenanthrolinyl, phenazinyl, phenoxazinyl, phenothiazinyl, oxazolyl, thiazolyl, isoxaloyl, and hydrogenated forms thereof known to those in the art. Preferred hetrerocyclyl groups include imidazolyl, pyrazolyl, pyrazinyl, pyridyl, furyl, pyrrolyl, thienyl, pyrimidinyl, pyridazinyl, pyranyl, and indolyl.

Ethylenically unsaturated monomers that may be included as a diluent, reactant or co-reactant and may include those such as, for example, vinyl aromatics such as styrene and styrene derivatives such as α-methyl styrene, p-methyl styrene, divinyl benzene, divinyl toluene, ethyl styrene, vinyl toluene, tert-butyl styrene, monochloro styrenes, dichloro styrenes, vinyl benzyl chloride, fluorostyrenes, tribromostyrenes, tetrabromostyrenes, and alkoxystyrenes (e.g., paramethoxy styrene). Other monomers which may be used include, 2-vinyl pyridine, 6-vinyl pyridine, 2-vinyl pyrrole, 2-vinyl pyrrole, 5-vinyl pyrrole, 2-vinyl oxazole, 5-vinyl oxazole, 2-vinyl thiazole, 5-vinyl thiazole, 2-vinyl imidazole, 5-vinyl imidazole, 3-vinyl pyrazole, 5-vinyl pyrazole, 3-vinyl pyridazine, 6-vinyl pyridazine, 3-vinyl isoxozole, 3-vinyl isothiazole, 2-vinyl pyrimidine, 4-vinyl pyrimidine, 6-vinyl pyrimidine, any vinyl pyrazine. Classes of other vinyl monomers also include, but are not limited to, (meth)acrylates, other vinyl aromatic monomers, vinyl halides and vinyl esters of carboxylic acids.

Examples include but are not limited to oxyranyl (meth)acrylates like 2,3-epoxybutyl (meth)acrylate, 3,4-epoxybutyl (meth)acrylate, 10,11 epoxyundecyl (meth)acrylate, 2,3-epoxycyclohexyl (meth)acrylate, glycidyl (meth)acrylate, hydroxyalkyl (meth) acrylates like 3-hydroxypropyl (meth)acrylate, 2,5-dimethyl-1,6-hexanediol (meth)acrylate, 1,10-decanediol (meth)acrylate, aminoalkyl (meth)acrylates like N-(3-dimethylaminopentyl (meth)acrylate, 3-dibutylaminohexadecyl (meth)acrylate; nitriles of (meth)acrylic acid and other nitrogen containing (meth)acrylates like N-((meth)acryloyloxyethyl)diisobutylketimine, N-((meth)acryloylethoxyethyl)dihexadecylketimine, (meth)acryloylamidoacetonitrile, 2-(meth)acryloxyethylmethylcyanamide, cyanoethyl (meth)acrylate, aryl (meth)acrylates like benzyl (meth)acrylate or phenyl (meth)acrylate, where the acryl residue in each case can be unsubstituted or substituted up to four times; carbonyl-containing (meth)acrylates like 2-carboxyethyl (meth)acrylate, carboxymethyl (meth)acrylate, oxazolidinylethyl (meth)acrylate, N-((meth)acryloyloxy) formamide, acetonyl (meth)acrylate, N-(meth)acryloylmorpholine, N-(meth)acryloyl-2-pyrrolidinone, N-(2-(meth)acryloxyoxyethyl)-2-pyrrolidinone, N-(3-(meth)acryloyloxypropyl)-2-pyrrolidinone, N-(2-(meth)acryloyloxypentadecenyl)-2-pyrrolidinone, N-(3-(meth)acryloyloxyheptadecenyl)-2-pyrrolidinone; (meth)acrylates of ether alcohols like tetrahydrofurfuryl (meth)acrylate, vinyloxyethoxyethyl (meth)acrylate, methoxyethoxyethyl (meth)acrylate, 1-butoxypropyl (meth)acrylate, 1-methyl-(2-vinyloxy)ethyl (meth)acrylate, cyclohexyloxymethyl (meth)acrylate, methoxymethoxyethyl (meth)acrylate, bezyloxymethyl (meth)acrylate, furfuryl (meth)acrylate, 2-butoxyethyl (meth)acrylate, 2-ethoxyethoxymethyl (meth)acrylate, 2-ethoxyethyl (meth)acrylate, allyloxymethyl (meth)acrylate, 1-ethoxybutyl (meth)acrylate, ethoxymethyl(meth)acrylate; (meth)acrylates of halogenated alcohols, like 2,3-dibromopropyl (meth)acrylate, 4-bromophenyl (meth)acrylate1,3-dichloro-2-propyl (meth)acrylate, 2-bromoethyl (meth)acrylate, 2-iodoethyl (meth)acrylate, chloromethyl (meth)acrylate, 2-isocyanatoethyl methacrylate, vinyl isocyanate, 2-acetoacetoxyethyl methacrylate; phosphorus-, boron, and/or silicon-containing (meth)acrylates like 2-(dimethylphosphato)propyl (meth)acrylate, 2-(ethylphosphito)propyl (meth)acrylate, dimethylphosphinoethyl (meth)acrylate, dimethylphosphinomethyl (meth)acrylate, dimethylphosphonoethyl (meth)acrylate, dimethyl(meth)acryloyl phosphonate, dipropyl(meth)acryloyl phosphate, 2-(dibutylphosphono)ethyl methacrylate, 2,3-butelene(meth)acryloylethyl borate, methyldiethoxy(meth)acryloylethoxysilane, vinyltrimethoxysilane, vinyltriethoxysilane, vinyltrichlorosilane, allyltrichlorosilane, allyltrimethoxysilane, allyltriethoxysilane, γ-methacryloxypropylmethoxysilane, diethylphosphatoethyl (meth)acrylate; sulfur-containing (meth)acrylates like ethylsulfinylethyl (meth)acrylate, 4-thiocyanatobutyl (meth)acrylate, ethylsulfonylethyl (meth)acrylate, thiocyanathomethyl (meth)acrylate, methylsulfonylmethyl (meth)acrylate, bis((meth)acryloyloxyethyl) sulfide.

### Polyfunctional Ethylenically Unsaturated Monomers

Suitable polyfunctional acrylates may be used in the resin composition of this invention, including those described, for example, in U.S. Pat. No. 5,925,409 to Nava. Such compounds include, but are not limited to, ethylene glycol (EG) dimethacrylate, butanediol dimethacrylate, hexane diol dimethacrylate and the like. The polyfunctional formula: 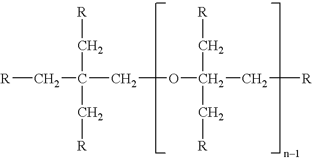
wherein at least four of the represented R's present are (meth)acryloxy groups, with the remainder of the R's being an organic group except (meth)acryloxy groups, and n is an integer from 1 to 5. Examples of polyfunctional acrylates include ethoxylated trimethyolpropane triacrylate, trimethyolpropane tri(meth)acrylate, trimethyolpropane triacrylate, trimethylolmethane tetra(meth)acrylate, pentaerythritol tetra(meth)acrylate, dipentaerythritol tetra(meth)acrylate, dipentaerythritol penta(meth)acrylate, and dipentaerythritol hexa(meth)acrylate; heterocyclic (meth)acrylates like 2-(1-imidazolyl)ethyl (meth)acrylate, 2-(4-morpholyl)ethyl (meth)acrylate and 1-(2-(meth)acryloyloxyethyl)-2-pyrrolidinone; vinyl benzoate and isoprenyl esters; crotonic acid, itaconic acid or anhydride, maleic acid and maleic acid derivatives such as mono and diesters of maleic acid, maleic anhydride, methyl maleic anhydride, methylmaleimide; fumaric and fumaric acid derivatives such as mono and diesters of fumaric acid.

### Other Unsaturated Monomers

Suitable polyfunctional “olefins” may be used in the resin composition of this invention. As use herein and in the claims, by “olefin” and the like terms is meant unsaturated aliphatic hydrocarbons having one or more double bonds, obtained by cracking petroleum fractions. Specific examples of olefins may include, but are not limited to, propylene, 1-butene, 1,3-butadiene, isobutylene and di-isobutylene.

As used herein and in the claims, by “(meth)allylic monomer(s)” is meant monomers containing substituted and/or unsubstituted allylic functionality, i.e., one or more radicals represented by the following general formula:
H₂C═C(Q)-CH₂—
Wherein Q is a hydrogen, halogen or a C₁ to C₄ alkyl group. Most commonly, Q is a hydrogen or a methyl group, but are not limited to; (meth)allyl alcohol; (meth)allyl ethers, such as methyl (meth)allyl ether, (meth)allyl esters of carboxylic acids, such as (meth)allyl acetate, (meth)allyl benzoate, (meth)allyl n-butyrate, (meth)allyl esters of VERSATIC acid, and the like. The components can be used individually or as mixtures.

### Polymerization Inhibitors

Polymerization inhibitors may also be included in the polymerization mixture such as phenol, 2,6-di-tert-butyl-4-methyl phenol, hydroquinone (HQ), tolu-hydroquinone (THQ), bisphenol “A” (BPA), naphthoquinone (NQ), p-benzoquinone (p-BQ), butylated hydroxy toluene (BHT), Hydroquinone monomethyl ether (HQMME), 4-ethoxyphenol, 4-propoxyphenol, and propyl isomers thereof, monotertiary butyl hydroquinone (MTBHQ), ditertiary Butyl hydroquinone (DTBHQ), tertiary butyl catechol (TBC), 1,2-dihydroxybenzene, 2,5-dichlorohydroquinone, 2-acetylhydroquinone, 1,4-dimercaptobenzene, 4-aminophenol, 2,3,5-trimethylhydroquinone, 2-aminophenol, 2-N,N,-dimethylaminophenol, catechol, 2,3-dihrydroxyacetrophenone, pyrogallol, 2-methylthiophenol, Sb(Ph)₃. Other substituted and un-substituted phenols and mixtures of the above.

Other inhibitors that may be used include oxime compounds of the following formula: 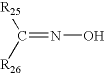
where R₂₅ and R₂₆ are the same or different and are hydrogen, alkyl, aryl, aralkyl, alkyl hydroxyaryl or aryl hydronyalkyl groups having three to about 20 carbon atoms. The skill in the art will find valuable advice for choosing these components in international patent WO 98/14416.

Hydroxylamines can also be use as inhibitors with the following formula: 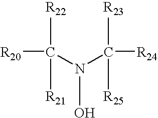
where R₂₀, R₂₁, R₂₅ and R₂₄ are the same or different straight chain or branch substituted or unsubstituted alkyl groups of a chain length. R₂₃ and R₂₄ are independently selected from the group consisting of halogen, cyano, COOR₂₀, —S—COR₂₀, —OCOR₂₀, amido, —S—C₆H₅, carbonyl, alkenyl, or alkyl of 1 to 15 carbon atoms, or may be part of a cyclic structure which may be fused with it another saturated or aromatic ring.

Nitroxide initiators can also be used as inhibitors. Additional amount of nitroxide can be added after the polymerization has been completed as required to inhibit or delay any premature gelation of the reactive intermediates. Initiators used in the mixtures of the present invention include stable hindered nitroxide compounds having the structural formula: 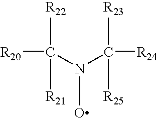
where R₂₀, R₂₁, R₂₅ and R₂₄ are the same or different straight chain or branch substituted or unsubstituted alkyl groups of a chain length. R₂₃ and R₂₄ are independently selected from the group consisting of halogen, cyano, COOR₂₀, —S—COR₂₀, —OCOR₂₀, amido, —S—C₆H₅, carbonyl, alkenyl, or alkyl of 1 to 15 carbon atoms, or may be part of a cyclic structure which may be fused with it another saturated or aromatic ring.

In a particular preferred embodiment, the stable hindered nitroxyl compound has the structural formula: 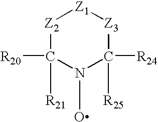
wherein Z₁, Z₂ and Z₃ are independently selected from the group consisting of oxygen, sulfur, secondary amines, tertiary amines, phosphorus of various oxidation states, and substituted and unsubstituted carbon atoms, such as >CH₂, >CHCH₃, >C═O, >C(CH₃)₂, >CHBr, >CHCl, >CHI, >CHF, >CHOH, >CHCN, >CH(OH)CN, >CHCOOH, >CHCOOCH₃, >CHC₂H₅, >C(OH)COOC₂H₅, >C(OH)COOCH₃, >C(OH)CH(OH)C₂H₅, >CR₂OR₂₁, >CHNR₂₀R₂₁, >CCONR₂₀R₂₁, >C═NOH, >C═CH—C₆H₅, >CF₂, >CCl₂, >CBr₂, >CI₂, and the like. Additional useful stable hindered nitroxyl initiators are described in patent publications WO 01/40404 A1, WO01/40149 A2, WO 01/42313 A1, U.S. Pat. Nos. 4,141,883, 6,200,460 B1, 5,728,872, and U.S. Patent Application No. 2004/0143051A1, and are incorporated herein by reference in their entireties.

Examples of nitroxide free radical initiators include but are not limited to 2,2,6,6-tetramethyl-1-piperidinyloxy (“TEMPO”), 4-hydroxy-2,2,6,6-tetramethyl-1-piperidinyloxy (“4-hydroxy TEMPO”), 3-carbamoyl-2,2,5,5-tetramethylpyrrolidin-1-yloxy, 3-carbamoyl-2,2,5,5-tetramethyl-3-pyrrolin-1-yloxy, di-t-butyl nitroxide and 2,6,-di-t-butyl-a-(3,5-di-t-butyl-4-oxo-2,5-cyclohexadien-1-ylidene)-p-tolyloxy.

### Fatty Acid and Fatty oils Intermediates

Fatty acids and fatty oils may be used in the preparation of polyesters without restriction and used in the present invention. Although prepolymerized fatty acids, fatty oils or their fatty acid esters prepared according to known processes are usually used. A polybasic polymerized fatty acid prepared by polymerizing a higher fatty acid or higher fatty acid ester is preferable because can provide better adhesiveness, flexibility, water resistant and heat resistance, providing a well balance mixture with improved properties. The fatty acid or fatty oils may be any of saturated and unsaturated fatty acids, and the number of carbons may be from 8 to 30, preferably 12 to 24, and further preferably 16 to 20. As the fatty ester, alkyl esters, such as methyl, ethyl, propyl, butyl, amyl and cyclohexyl esters and the like.

Preferable polymerized fatty acids include polymerized products of unsaturated higher fatty acids such as oleic acid, linoleic acid, resinoleic acid, eleacostearic acid and the like. Polymerized products of tall oil fatty acid, beef tallow fatty acid and the like, etc., can be also used. Hydrogenated polymerized fatty esters or oils can also be used. Portions of the dibasic carboxylic acid (herein after referred to as “dimer acid”) and three or higher basic carboxylic acid in the polymerized fatty acid is not particularly limited, but the proportions may be selected appropriately according to the ultimate properties expected. Trimer acids or higher carboxylic acids may also be used.

The polymerization of the fatty acid esters is not particularly limited; alkyl esters of the above mentioned polymerized fatty acids are usually used as the polymerized fatty acid esters. As said alkyl esters such as methyl ester, ethyl ester, propyl ester, isopropyl ester, butyl ester, amyl ester, hexyl ester and the like and higher alkyl esters such as octyl ester, decyl ester, dodecyl ester, pentadecyl ester, octadecyl ester and the like can be used, among which preferable are lower alkyl esters and more preferable are methyl ester, ethyl ester and butyl ester.

These polymerized fatty acids, fatty oils and polymerized fatty acid esters can be used either alone or in combination of two or more. Although proportion of the sum of the polymerized fatty acids and the polymerized fatty acid esters in the total polybasic carboxylic acid is not particularly limited and may be used in different rations ranging from 3 to 40% by weight of the resin composition.

### Epoxy Intermediates

Also compounds that may be included in this invention are epoxy compounds which include a wide variety of epoxy compounds. Typically, the epoxy compounds are epoxy resins which are also referred as polyepoxides. Polyepoxides useful herein can be monomeric (i.e. the diglycidyl ether of bisphenol A), advanced higher molecular weight resins, or polymerized unsaturated monoepoxides (i.e., glycidyl acrylates, glycidyl methacrylates, allyl glycidyl ether, etc.) to homopolymers or copolymers. Most desirable, epoxy compounds contain, on the average, at least one pendant or terminal 1,2-epoxy group (i.e., vicinal epoxy group per molecule).

Examples of the useful polyepoxides include the polyglicidyl ethers of both polyhydric alcohols and polyhydric phenols; polyglycidyl amines, polyglycidyl amides, polyglycidyl imides, polyglycidyl hydantoins, polyglycidyl thioethers, polyglycidyl fatty acids, or drying oils, epoxidized polyolefins, epoxidized di-unsaturated acid esters, epoxidized unsaturated polyesters, and mixtures thereof. Numerous epoxides prepared from polyhydric phenols include those which are disclosed, for example, in U.S. Pat. No. 4,431,782. Polyepoxides can be prepared from mono-, di- and trihydric phenols, and can include the novolac resins. The polyepoxides can include the epoxidized cycloolefins; as well as the polymeric polyepoxides which are polymers and copolymers of glycidyl acrylates, glycidyl methacrylate and allylglycidyl ether. Suitable polyepoxides are disclosed in U.S. Pat. Nos. 3,804,735; 3,893,829; 3,948,698; 4,014,771 and 4,119,609 the disclosures of which are incorporated herein by reference in their entireties; and Lee and Naville, Handbook of Epoxy Resins, Chapter 2, McGraw Hill, New York (1967).

While the invention is applicable to a variety of polyepoxides, generally preferred polyepoxides are glycidyl polyethers of polyhydric alcohols or polyhydric phenols having weights per epoxide of 150 to 2,000. These polyepoxides are usually made by reacting at least about two moles of an epihalohydrin or glycerol dihalohydrin with one mole of the polyhydric alcohol or polyhydric phenol, and sufficient amount of a caustic alkali to combine with the halogen of the halohydrin. The products are characterized by the presence of more than one epoxide group, i.e., a 1,2-epoxy equivalency greater than one.

The compositions may also include a monoepoxide, such as butyl glycidyl ether, phenyl glycidyl ether, or cresyl glycidyl ether, as a reactive diluent. Such reactive diluents are commonly added to polyepoxide formulations to reduce the working viscosity thereof, and to give better wetting to the formulation.

### Thickening Agents

A thickening agent is added to the compositions in the range of 0.05 to 10%, preferably in the range of 0.2 to 5% by weight of the chemical thickener, based on the weight of the molding compound. The thickening agent is added to facilitate increasing the viscosity of the compounding mixture. Examples include CaO, Ca(OH)₂, MgO or Mg(OH)₂. Any suitable chemical thickener contemplated by one skill in the molding compound art may be used. The thickening agent(s) coordinate with carboxyl groups present in the polymer of the present invention or to any other polymer added therewith from those described above.

Other thickening agents that may also be included are isocyanates. These materials react with hydroxyl groups that may be present in the polymers of this invention or in other polymer added therewith from those described above. Polyisocyanates employed in the present invention are aromatic, aliphatic and cycloaliphatic polyisocyanates having 2 or more isocyanate groups per molecule and having an isocyanate equivalent weight of less than 300. Preferably the isocyanates are essentially free from ethylenic unsaturation and have no other substituents capable of reacting with the unsaturated polyester. Polyfunctional isocyanates which are used in the above reactions are well known to the skilled artisan. For the purposes of the invention, diisocyantes include aliphatic, cycloaliphatic, araliphatic, aromatic and heterocyclic diisocyantes of the type described, for example, by W. Siefken in Justus Liebigs Annalen der Chemie, 562, pages 75 to 136, (1949) for example, those corresponding to the following formula:
OCN—R—(NCO)ₙ
wherein n is equal to 1 to 3 and R represents a difunctional aliphatic, cycloaliphatic, aromatic, or araliphatic radical having from about 4 to 25 carbon atoms, preferably 4 to 15 carbon atoms, and free of any group which can react with isocyanate groups. Exemplary diisocyantes include, but are not limited to, toluene diisocyanate; 1,4-tetramethylene diisocyanate; 1,4-hexamethylene diisocyanate; 1,6-hexamethylene diisocyanate; 1,12-dodecane diisocyanate; cyclobutane-1,3-diisocyanate; cyclohexane-1,3-diisocyanate; cyclohexane-1,4-diisocyanate; 1-isocyanato-3,3,5-trimethyl-5-isocyanatomethyl cyclohexane; 2,4-hexahydrotolylene diisocyanate; 2,6-hexahydrotolylene diisocyanate; 2,6-hexahydro-1,3-phenylene diisocyanate; 2,6-hexahydro-1,4-phenylene diisocyanate; per-hydro-2,4′-diphenyl methane diisocyanate; per-hydro-4,4′-diphenyl methane diisocyanate; 1,3-phenylene diisocyanate; 1,4-phenylene diisocyanate; 2,4-tolylene diisocyanate, 2,6-toluene diisocyanates; biphenyl methane-2,4′-diisocyanate; biphenyl methane-4,4′-diisocyanate; naphthalene-1,5-diisocyanate; 1,3-xylylene diisocyanate; 1,4-xylylene diisocyanate; 4,4′-methylene-bis(cyclohexyl isocyanate); 4,4′-isopropyl-bis-(cyclohexyl isocyanate); 1,4-cyclohexyl diisocyanate; 3-isocyanatomethyl-3,5,5-trimethylcyclohexyl isocyanate (IPDI); 1-methyoxy-2,4-phenylene diisocyanate; 1-chloropyhenyl-2,4-diisocyante; p-(1-isocyanatoethyl)-phenyl isocyanate; m-(3-isocyanatobutyl)-phenyl isocyanate; and 4-(2-isocyanate-cyclohexyl-methyl)-phenyl isocyanate. Mixtures of any of the above may be employed. When deemed appropriate, a diisocyanate may be employed which contains other functional groups such as amino functionality.

Polyfunctional isocyanate additives of the molding compositions of this invention may include a dual-functional additive prepared by the one step-addition reaction between one equivalent weight of a diol or triol of molecular weight from 60 to 3000 and an excess of the polyfunctional isocyanate. The polyfunctional isocyanate excess is added in a quantity sufficient to allow unreacted polyfunctional isocyanate remain free in the mixture after the reaction with the diol or triol in an amount of 0.01 to 50% by weight of the total mixture and most preferable in an amount of 1 to 30% by weight of the mixture. In the reaction involving the diol or triol with the polyfunctional isocyanate, it is preferred to employ a catalyst. A number of catalysts know to the skill artisan may be used for this purpose. Suitable catalysts are described in U.S. Pat. Nos. 5,925,409 and 4,857,579, the disclosures of which are hereby incorporated by reference in their entireties. Examples of the polyhydric alcohol having at least 2 hydroxyl groups in the molecule and a hydroxyl value of 35 to 1,100 mgKOH/g include ethylene glycol, propylene glycol, diethylene glycol, triethylene glycol, 1,5-pentane diol, 1,6-hexane diol, polyethylene glycol and polypropylene having a molecular weight of 200 to 3000, polytetramethylene glycol having a molecular weight of 200 to 3000, etc.

The process of the invention may employ a carbodiimide, preferably a carbodiimide intermediate containing from about 1 to about 1000 repeating units. Polycarbodiimides are preferably utilized. The carbodiimides depending on the amount added are used to react with the resin or components having active hydrogens. For example to lower the acid number of the unsaturated polyester resin or to increase the viscosities of the resins to form a gel like material. Exemplary carbodiimides are described in U.S. Pat. No. 5,115,072 to Nava et al., the disclosure of which is incorporated herein by reference in its entirety.

In general, the carbodiimides preferably are polycarbodiimides that include aliphatic, cycloaliphatic, or aromatic polycarbodiimides. The polycarbodiimides can be prepared by a number of reaction schemes known to those skilled in the art. For example, the polycarbodiimides may be synthesized by reacting an isocyanate-containing intermediate and a diisocyanate under suitable reaction conditions. The isocyanate containing intermediate may be formed by the reaction between a component, typically a monomer containing active hydrogens, and a diisocyanate. Included are also polycarbodiimides prepared by the polymerization of isocyanates to form a polycarbodiimide, which subsequently react with a component containing active hydrogens.

Preferably, the carbodiimide intermediate is represented by the formula selected from the group consisting of: 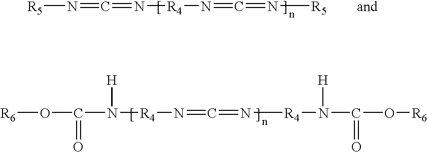
wherein:

R₄ and R₅ are independently selected from the group consisting of alkyl, aryl, and a compound containing at least one radical;

R₆ may be a monomeric unit or a polymeric unit having from 1 to 1000 repeating units; and

n ranges from 0 to 100;

The carbodiimide is preferably used in a percentage ranging from about 0.10 to about 50% by weight based on the weight of reactants, and more preferably from about 1 to about 20 percent by weight.

### Other Additives

Additional additives known by the skilled artisan may be employed in the resin composition of the present invention including, for example, paraffins, lubricants, flow agents, air release agents, flow agents, wetting agents, UV stabilizers, radiation curing initiators (i.e., UV curing initiators) and shrink-reducing additives. Various percentages of these additives can be used in the resin compositions.

Internal release agents are preferably added to the molding composition according to the invention. Aliphatic metal slats such as zinc stearate, magnesium stearate, calcium stearate or aluminum stearate can be used as the internal release agent. The amount of internal release agent added is in the range of 0.5 to 5.0% by weight, more preferably in the range of from 0.4% to 4.0% by weight. Hence, stable release can be made at the time of demolding without occurrence of any crack on the molded product.

Acrylic resins prepared by radical polymerization may be used in the mixtures. The acrylic resin preferably has an acid number ranging from about 1 to 100 mg of KOH/g, more preferably from about 5 to 50 mg of KOH/g, and most preferably from about 10 to 30 mg of KOH/g. The acrylic resin preferably has a hydroxyl number ranging from 5 to 300, more preferably from about 25 to 200, and most preferably from 50 to 150. The acrylic resin has a preferred number average molecular weight, determined by GPC versus polystyrene standards, from about 1000 to about 100,000, and more preferably from about 2000 to about 50,000. The acrylic resin has a polydispersity preferably from about 1.5 to about 30, more preferably from about 2 to 15. The Tg of the acrylic resin, measured by Differential Scanning Calorimetry, is preferably from about −30° C. to about 150° C., and more preferably from about −10° C. to about 80° C.

The styrene acrylic resins which are used are preferably formed from about 0.5 to 30 percent by weight of a functional mercaptam which contains carboxyl, hydroxyl, siloxy, or sulfonic acid groups (most preferably from about 1 to 15 percent by weight), and from about 70 to about 99.5 percent by weight of an ethylenically unsaturated monomer (most preferably 85 to 99 percent by weight). Exemplary styrene/acrylic resins are described in Boutevin et al., Eur. Polym. J., 30; No. 5, pp. 615-619, and Rimmer et al., in Polymer, 37; No. 18, pp. 4135-4139. Also included are block copolymers of alkenyl aromatic hydrocarbons and alkylene oxides described in U.S. Pat. Nos. 3,050,511 and 3,836,600.

Various hydroxyl and carboxyl terminated rubbers may be also used as toughening agents. Examples of such materials are presented in U.S. Pat. No. 4,100,229, the disclosure of which is incorporated by reference herein in its entirety; and in J. P. Kennedy, in J. Macromol. Sci. Chem. A21, pp. 929(1984). Such rubbers include, for example, carbonyl-terminated and hydroxyl polydienes. Exemplary carbonyl-terminated polydienes are commercially available from BF Goodrich of Cleveland, Ohio, under the trade name of Hycar™. Exemplary hydroxyl-terminated Polydienes are commercially available from Atochem, Inc., of Malvern, Pa., and Shell Chemical of Houston, Tex..

A number of polysiloxanes may be used as toughening agents. Examples of suitable polysiloxanes include poly(alkylsiloxanes), (e.g., poly(dimethyl siloxane)), which includes compounds which contain silanol, carboxyl, and hydroxyl groups. Examples of polysiloxanes are described in Chiang and Shu, J. Appl. Pol. Sci. 361, pp. 889-1907, (1988). Various hydroxyl and carboxyl terminated polyesters prepared from lactones (e.g., gamma-butyrolactone, etha-caprolactone), as described in Zhang and Wang, Macromol. Chem. Phys. 195, 2401-2407 (1994); In't Velt et al, J. Polym. Sci. Part A, 35, 219-216 (1997); Youqing et al, Polym. Bull. 37, 21-28 (1996). Various Telechelic Polymers as those described in “Telechelic Polymers: Synthesis and Applications”, Editor: Eric J. Goethals, CRC Press, Inc. 1989, are also included in this invention.

Various polyethoxylated and polypropoxylated hydroxyl terminated polyethers derived from alcohols, phenols (including alkyl phenols), and carboxylic acids can be used as toughening agents. Alcohols which may be used in forming these materials include, but are not limited to, tridecyl alcohol, lauryl alcohol, solely alcohol, and mixtures thereof. Commercially suitable polyethoxylated and polypropoxylated oleyl alcohol are sold under the trade name of Rhodasurf™ by Rhone-Poulenc of Cranbury, N.J., along with Trycol™ by Emery Industries of Cincinnati, Ohio. Examples of phenols and alkyl phenols which may be used include, but are not limited to, octyl phenol, nonyl phenol, tristyrylphenol, and mixtures thereof. Commercially suitable tristyrylphenols include, but are not limited to, Igepal™ by Rhone-Poulenc, along with Triton™ by Rohm and Haas of Philadelphia, Pa.

### Fiber Reinforcement

The addition of fiber(s) provides a means for strengthening or stiffening the polymerized cured composition. The types often used are:

Inorganic crystals or polymers, e.g., fibrous glass, quartz fibers, silica fibers, fibrous ceramics, e.g., alumina-silica (refractory ceramic fibers); boron fibers, silicon carbide, silicon carbide whiskers or monofilament, metal oxide fibers, including alumina-boric-silica, alumina-chromia-silica, zirconia-silica, and others;

Organic polymer fibers, e.g., fibrous carbon, fibrous graphite, acetates, acrylics (including acrylonitrile), aliphatic polyamides (e.g. nylon), aromatic polyamides, olefins (e.g., polypropylenes, polyesters, ultrahigh molecular weight polyethylenes), polyurethanes (e.g., Spandex), alpha-cellulose, cellulose, regenerated cellulose (e.g., rayon), jutes, sisal, vinyl chlorides, vinylidenes, flax, and thermoplastic fibers;

Metal fibers, e.g., aluminum, boron, bronze, chromium, nickel, stainless steel, titanium or their alloys; and “whiskers”, single, inorganic crystals.

### Fillers

Suitable filler(s) non-fibrous are inert, particulate additives being essentially a means of reducing the cost of the final product while often reducing some of the physical properties of the polymerized cured compound. Fillers used in the invention include calcium carbonate of various form and origins, silica of various forms and origins, silicates, silicon dioxides of various forms and origins, clays of various forms and origins, feldspar, kaolin, flax, zirconia, calcium sulfates, micas, talcs, wood in various forms, glass (milled, platelets, spheres, micro-balloons), plastics (milled, platelets, spheres, micro-balloons), recycled polymer composite particles, metals in various forms, metallic oxides or hydroxides (except those that alter shelf life or viscosity), metal hydrides or metal hydrates, carbon particles or granules, alumina, alumina powder, aramid, bronze, carbon black, carbon fiber, cellulose, alpha cellulose, coal (powder), cotton, fibrous glass, graphite, jute, molybdenum, nylon, orlon, rayon, silica amorphous, sisal fibers, fluorocarbons and wood flour.

The fibrous materials may be incorporated into the resin in accordance with techniques which are known in the art. Fillers may include but are not limited to calcium carbonate, calcium sulfate, talc, aluminum oxide, aluminum hydroxide, silica gel, barite, carbon powder, etc. Preferably, the filler is added in amount between 0 to 80% by weight and more preferably in an amount of 20 to 60% by weight based on the resin composition.

### Curing Accelerators/Promoters

Suitable curing accelerators or promoters may also be used and include, for example, cobalt naphthanate, cobalt octoate, 2,4-pentanedione, N,N-diethyl aniline, N,N-dimethyl aniline, N,N-dimethyl acetamide, triethyl amine, triethanol amine, N,N-dimethyl p-toluidine, and other tertiary amines. Other salts of lithium, potassium, zirconium, calcium and copper. Mixtures of the above may be used. The curing accelerators or promoters are preferably employed in amounts from about 0.005 to about 1.0 percent by weight, more preferably from about 0.1 to 0.5 percent by weight, and most preferably from about 0.1 to 0.3 percent by weight of the resin.

### Curing Catalysts

The curing of the polymer mixtures of the present inventions also includes a catalyst such as an organic peroxide compound. Depending on the choice of peroxide and promoters, the polymer mixtures can be cured at temperatures, not bound to any limitations, that can be from about −10° C. to about 150° C. to produce a crosslinked material. Exemplary organic peroxides are selected from a list that includes, but is not limited to the following:
Diacyl peroxides such as benzoyl peroxides, t-butyl peroxybenzoate; t-amyl peroxybenzoate; ketone peroxides such as mixtures of peroxides and hydroperoxides; methyl isobutyl ketone; 2,4-pentanedione peroxide; methyl ethyl ketone peroxide/perester blend;
peroxydicarbonates such as di(n-propyl)peroxydicarbonate, di(sec-butyl)peroxydicarbonate; di(2-ethylhexyl)peroxydicarbonate; bis(4-t-butyl-cyclohexyl) peroxydicarbonate; diisopropyl peroxydicarbonate; diacetyl peroxydicarbonate;
peroxyesters such as alpha-cumyl peroxydecanoate; alpha-cumyl peroxyneoheptanoate; t-butylperoxyneodecanoate; t-butylperoxypivalate; 1,5-dimethyl 2,5-di(2-ethylhexanoyl peroxy)hexane; t-butylperoxy-2-ethylhexanoate; t-butylperoxy isobutyrate; t-butylperoxymaleic acid; t-butyl-isopropyl carbonate2,5-dimethyl-2,5-di(benzoylperoxy)hexane; t-butylperoxy-acetate; t-butylperoxybenzoate; di-t-butylperoxy acetate; t-butyl peroxybenzoate; di-t-butyl diperoxyphthalate; mixtures of the peroxy esters and peroxyketal; t-amylperoxyneodecanoate; t-amylperoxypivalate; t-amylperoxy(2-ethylhexanoate); t-amylperoxyacetate; t-amylperoxy(2-ethylhexanoate); t-amylperoxyacetate; t-amylperoxybenzoate; t-butylperoxy-2-methyl benzoate;
dialkylperoxides such as dicumyl peroxide; 2,5-dimethyl-2,5-di(t-butylperoxy)hexane; 2,5-dimethyl-2,5-di(t-butylperoxy)dexyne-3; t-butyl cumyl peroxide; a,a-bis(t-butylperoxy)diisopropylbenzene; di-t-butyl peroxide;
hydroperoxides such as 2,5-dihydro-peroxy-2,5-dimethylhexane; cumene hydroperoxide; t-butylhydroperoxide;
peroxyketals such as 1,1-di(t-butylperoxy) 3,3,5-trimethylcyclohexane; 1,1-di(t-butylperoxy)cyclohexane; ethyl-3,3-di(t-butylperoxy) butyrate; n-butyl 4,4-bis(t-butylperoxy)pivalate; cyclic peroxyketal; 1,1-di(t-amylperoxy)cyclohexane; 2,2-di-t-amylperoxy propane;
azo type initiators such as 2,2′-azobis(2,4-dimethylvaleronitrile); 2,2′azobis(isobutyronitrile); 2,2′azobis(methylbutyronitrile); 1,1′-azobis(cyanocyclohexane).

The preferred curing catalysts are: Diacyl peroxides such as benzoyl peroxides, t-butyl peroxybenzoate; t-amyl peroxybenzoate; ketone peroxides such as mixtures of peroxides and hydroperoxides; methyl isobutyl ketone; 2,4-pentanedione peroxide; methyl ethyl ketone peroxide/perester blend. Mixtures of any of the above may be used. The agent is preferably employed in an amount from about 0.01 to 5.0 weight percent based on the weight of the monomers, more preferably from about 0.5 to 3.0 percent by weight, and most preferably from about 1 to 1.5 percent by weight.

The unsaturated resins are particularly well suited for forming molded articles, including those used in storage tanks, automobile body panels, boat building, tub showers, culture marble, solid surface, polymer concrete, pipes and inner liners for pipeline reconstruction. Other applications include gelcoats and coatings. The unsaturated resins may be used alone or in conjunction with other appropriate materials. When the resins are used with other materials (e.g., fibrous reinforcements and fillers), they are typically used to form reinforced products such as storage tanks, automobile body panels, boat building, tub showers by any known process such as, for example pultrusion, sheet molding compounding (SMC), spray up, hand lay-up, resin transfer molding, vacuum injection molding, resin transfer molding and vacuum assisted resin transfer molding.

### Resins Used in Combination with the Unsaturated Polystyrene Thermosetting Resin

Described below are resins which have been blended using unsaturated thermosetting resins. All resins are available from Reichhold, Inc., Durham, N.C. Polylite® 31051-00 is a DCPD/maleic anhydride/diethylene glycol/ethylene glycol resin used for open mold applications such as spray up and hand lay-up; Polylite® 31453-00 is a DCPD/maleic anhydride/ethylene glycol resin used in open mold applications; Polylite® 33375-00 is a low molecular weight epoxy acrylate resin used for open mold applications such as spray up and hand lay-up; Polylite® 31025-00 is propylene glycol/maleic anhydride resin with high reactivity used in open and close molding applications.

### EXAMPLES

The following examples are provided to illustrate the present invention, and should not be construed as limited thereof. Viscosities were measured with a Brookfield Viscometer with a spindle #4 at 20 rpm and at 25° C.

Shrinkage measurements on the cured thermosetting resins were done using a graduated volumetric cylinder. The expansion observed was measure by the difference on volume increased in the cylinder.

In the examples, resin tensile strength was measured in accordance with ASTM Standard D-638; flexural strength was measured in accordance with ASTM Standard D-790; barcol hardness was determined in accordance with ASTM Standard D-2583; elongation was measured in accordance with ASTM Standard D-638; heat distortion (HDT) was measured in accordance with ASTM Standard D-648.

### Example 1

### PET-DEG Reactive Oligomer

Step 1:

13,839.56 g of Recycled polyethylene terephthalate (PET) and 8,130.74 g Diethylene glycol (DEG) were added into a reactor and dehydrated at 50° C. under a vacuum of 14.5 Psi. After dehydration, the pressure was returned to standard atmospheric pressure, circulating nitrogen and Zinc Acetate 20.18 g was added as a catalyst, then the reactor sealed. The trans-esterification reaction was performed under pressure at 230° C. for 6 hour. At this time, the solid polyethylene terephthalate dissolved completely and became a uniform viscous liquid.

Step 2:

In a reaction vessel, 2036 g PET-DEG polyol prepared as above having an OH value of 375, was combined with 1170 g of methacrylic acid, 30 g of p-Toluenesulphonic acid, 1.06 g of MTBHQ, 0.88 g of Phenothiazine, then a mixture of 380 g of toluene and 260 g of cyclohexane was introduced. The resulting mixture was heated to reflux temperature with continuous stirring, while a mixture of air and nitrogen were passed through the reaction mixture. The water formed from the reaction was separated, and the reaction was maintained under reflux until an acid number of about 45 (mgKOH/g substance) was reached. Then, another 5 g of p-Toluenesulphonic acid, and 62 g of ethylene glycol (EG), were added and the reaction was continued till the acid number of 25-28 was reached. Thereafter, the solvent in the reaction mixture was removed by distillation. Then 120 g of bisphenol A diglycidyl ether and 2 g of benzyltrimethyl ammonium chloride at 60% strength in isopropanol were added. After 2 hours at 100° C., the reaction mixture was cooled to 50° C. and discharged. The product had a viscosity of 340 cps.

### Example 2

In a reaction vessel, 844 g PET-DEG polyol (OH value 375) made from recycled PET and DEG, is combined with 289 g of methacrylic acid and 121 g of acrylic acid, 12 g of p-Toluenesulphonic acid, 0.42 g of MTBHQ, 0.35 g of Phenothiazine, then a mixture of 250 g of toluene and 70 g of cyclohexane is introduced. The resulting mixture was heated to reflux temperature with continuous stirring, while a mixture of air and nitrogen were passed through the reaction mixture. The water formed from the reaction mixture was separated, and the reaction was maintained under reflux until an acid number of about 40 (mgKOH/g substance) was reached. Thereafter, the solvent in the reaction mixture was removed by distillation. Then 40 g of bisphenol A diglycidyl ether and 1.2 g of benzyltrimethyl ammonium chloride at 60% strength in isopropanol were added. After 2 hours at 100° C., the reaction mixture was cooled to 50° C. and discharged. The product had a viscosity of 460 cps.

### Example 3

In a reaction vessel, 1990 g of a polyol made from dimethyl terephthalate (DMT) and 2-methyl propane diol (MPDiol) having a OH value 380, is combined with 772 g of methacrylic acid and 323 g of acrylic acid, 30 g of p-Toluenesulphonic acid, 1.2 g of MTBHQ, 0.95 g of Phenothiazine, then a mixture of 450 g of toluene and 300 g of cyclohexane was introduced. The resulting mixture was heated to reflux temperature with continuous stirring, while a mixture of air and nitrogen were passed through the reaction mixture. The water of the reaction which formed was separated and the reaction was maintained under reflux until an acid number of about 17-20 (mgKOH/g substance) was reached. Thereafter, the solvents in the reaction mixture were removed by distillation. Then 90 g of bisphenol A diglycidyl ether and 1.8 g of benzyltrimethyl ammonium chloride at 60% strength in isopropyl alcohol were added. After 2 hours at 100° C., the reaction mixture was cooled to 50° C. and discharged. The product had a viscosity of 530 cps.

### Example 4

In a reaction vessel, 812 g of a polyol made from dimethyl terephthalate and 2-methyl propane diol having a OH value 380, is combined with 315 g of methacrylic acid and 130 g of acrylic acid, 6 g of p-Toluenesulphonic acid, 0.4 g of MTBHQ, 0.38 g of phenothiazine, and 0.5 g SbPh3, then a mixture of 180 g of toluene was introduced. The resulting mixture was heated to reflux temperature (about 130-140° C.) with continuous stirring, while a mixture of air and nitrogen were passed through the reaction mixture. The water of the reaction which formed was separated and the reaction was maintained under reflux until an acid number of about 40-45 (mgKOH/g substance) was reached. Thereafter, the solvents in the reaction mixture were removed by distillation. Then 50 g of bisphenol A diglycidyl ether and 1.0 g of benzyltrimethyl ammonium chloride at 60% strength in isopropyl alcohol were added. After 2 hours at 100° C., the reaction mixture was cooled to 50° C. and discharged. The product had a viscosity of 100 cps.

### Example 5

Step 1:

In a reaction vessel, 803.5 g of DMT, is combined with 391 g of MPDiol, 460.8 g of DEG and 4 g of Zn(OAc)2 catalyst. The reaction mixture was slowly heated to 190° C. And during heating, methanol was distilled off. Then maintain this temperature for another 1 hour, stop heating and cool the reaction mixture down.

Step 2:

In a reaction vessel, 1016 g the above DMT-MPDiol-DEG polyol (OH value 360) from DMT, MPDiol and DEG, is combined with 382 g of methacrylic acid and 160 g of acrylic acid, 11 g of p-Toluenesulphonic acid, 0.6 g of MTBHQ, 0.47 g of phenothiazine, then an entrainer mixture of 225 g of toluene and 150 g of cyclohexane is introduced. The resulting mixture was heated to reflux temperature (about 100-110° C.) with continuous stirring, while a mixture of air and nitrogen were passed through the reaction mixture. The water of the reaction which formed was separated, and the reaction was maintained under reflux until an acid number of about 25 (mgKOH/g substance) was reached. Thereafter the reaction mixture was freed from azetropic entranier by distilation. Then 40 g of bisphenol A diglycidyl ether and 1 g of benzyltrimethyl ammonium chloride at 60% strength in isopropanol were added. After 2 hours at 100° C., the reaction mixture was cooled to 50° C. and discharged. The product had a viscosity of 505 cps.

### Example 6

Step 1:

In a reaction vessel, 829 g of DMT, is combined with 186 g of EG, 639 g of DEG, 1.8 g of antioxidant Doverphos S680 available from Dover Chemicals, and 1 g of Fascat 4102. The reaction mixture was slowly heated to 190° C. And during heating, methanol was distilled off. Then maintain this temperature for another 1 hour, stop heating and cool the reaction mixture down.

Step 2:

In a reaction vessel, 927 g the above DMT-EG-DEG polyol, is combined with 343 g of methacrylic acid and 143 g of acrylic acid, 13 g of p-Toluenesulphonic acid, 0.45 g of MTBHQ, 0.38 g of phenothiazine, then a mixture of 180 g of toluene and 140 g of cyclohexane was introduced. The resulting mixture was heated to reflux temperature (about 88-110° C.) with continuous stirring, while a mixture of air and nitrogen were passed through the reaction mixture. The water of the reaction which formed was separated, and the reaction was maintained under reflux until an acid number of about 30 (mgKOH/g substance) was reached. Thereafter the reaction mixture was freed from azetropic entranier by distilation. Then 37 g of bisphenol A diglycidyl ether and 1 g of benzyltrimethyl ammonium chloride at 60% strength in isopropyl alcohol were added. After 2 hours at 100° C., the reaction mixture was cooled to 50° C. and discharged. The product had a viscosity of 760 cps.

### Example 7

Step 1:

A polyol sample obtained from isophthalic acid, adipic acid and DEG made by standard esterification process with an acid number of 17-20 and an OH number of 285 was used in this example.

Step 2:

In a reaction vessel, 1998 g the above polyol (OH value 285), is combined with 611 g of methacrylic acid and 243.6 g of acrylic acid, 20 g of p-Toluenesulphonic acid, 1.2 g of MTBHQ, 0.95 g of PTZ, then a mixture of 450 g of toluene and 300 g of cyclohexane was introduced. The resulting mixture was heated to reflux temperature (about 90-110° C.) with continuous stirring, while a mixture of air and nitrogen were passed through the reaction mixture. The water of the reaction which formed was separated and the reaction was maintained under reflux until an acid number of about 50 (mgKOH/g substance) was reached. Thereafter, the solvents in the reaction mixture were removed by distillation. Then 96 g of bisphenol A diglycidyl ether and 2.0 g of benzyltrimethyl ammonium chloride at 60% strength in isopropyl alcohol were added. After 2 hours at 100° C., the reaction mixture was cooled to 50° C. and discharged. The product had a viscosity of 430 cps.

### Example 8

Step 1:

12,081.64 g of recycled polyethylene terephthalate and 9,892.44 g Diethylene glycol were added into a reactor. Under a Nitrogen flow, 17.62 g Zinc Acetate was added as a catalyst, then seal the reactor. And the ester exchange reaction was performed under 25 Psi. of pressure and at 235° C. for 5 hour. At this time, the solid polyethylene terephthalate dissolved completely, and it became a uniform viscous liquid.

Step 2:

In a reaction vessel, 1902 g PET-DEG polyol (OH value 475) made above from recycled PET and DEG, was combined with 1367 g of methacrylic acid, 30 g of p-Toluenesulphonic acid, 1.06 g of MTBHQ, 0.88 g of phenothiazine, then a mixture of 380 g of toluene and 260 g of cyclohexane was introduced. The resulting mixture was heated to reflux temperature with continuous stirring, while a mixture of air and nitrogen were passed through the reaction mixture. The water of the reaction which formed was separated, and the reaction was maintained under reflux until an acid number of about 45 (mgKOH/g substance) was reached. Then, another 5 g of p-Toluenesulphonic acid, and 62 g of EG, were added and the reaction was continued until an acid number of 25-28 reached. Thereafter, the solvent of the reaction mixture was removed by distillation. Then 120 g of bisphenol “A” diglycidyl ether and 2 g of benzyltrimethyl ammonium chloride at 60% strength in isopropyl alcohol were added. After 2 hours at 100° C., the reaction mixture was cooled to 50° C. and discharged. The product had a viscosity of 180 cps.

### Example 9

In a reaction vessel, 4605 lbs. PET-DEG polyol (OH value 475) from recycled PET and DEG, is combined with 2979 lbs. of methacrylic acid, 73 lbs. of p-Toluenesulphonic acid, 2.6 lbs. of MTBHQ, 2.1 lbs. of phenothiazine, then a mixture of 1550 lbs. of toluene is introduced. The resulting mixture was heated to reflux temperature with continuous stirring, while a mixture of air and nitrogen were passed through the reaction mixture. The water of the reaction which formed was separated, and the reaction was maintained under reflux until an acid number of about 45 (mgKOH/g substance) was reached. Then, another 12.11 lbs. of p-Toluenesulphonic acid, and 150 lbs. of EG, were added and reaction was continued till the acid number of 25-35 reached. Thereafter, the solvent of the reaction mixture was removed by distillation. Then 291 lbs. of bisphenol A diglycidyl ether and 4.8 lbs. of trimethylammonium chloride at 50% strength in water were added. After 2 hours at 100° C., the reaction mixture was cooled to 50° C. and discharged. The product had a viscosity of 180 cps.

### Example 10

In a reaction vessel, 4605 lbs. PET-DEG polyol (OH value 475) from recycled PET and DEG, is combined with 3310 lbs. of methacrylic acid, 73 lbs. of p-Toluenesulphonic acid, 2.6 lbs. of MTBHQ, 2.1 lbs. of phenothiazine, then a mixture of 1550 lbs. of toluene was introduced. The resulting mixture was heated to reflux temperature with continuous stirring, while a mixture of air and nitrogen were passed through the reaction mixture. The water of the reaction which formed was separated, and the reaction was maintained under reflux until an acid number of about 60 (mgKOH/g substance) was reached. Then, another 12.11 lb of p-Toluenesulphonic acid, and 154 lbs. of EG, were added and reaction was continued till the acid number of 40 reached. Thereafter, the solvent of the reaction mixture was removed by distillation. Then 291 lbs. of bisphenol “A” diglycidyl ether and 4.8 lbs. of trimethylammonium chloride at 50% strength in water were added. After 2 hours at 100° C., the reaction mixture was cooled to 50° C. and discharged. The product had a viscosity of 280 cps.

### Examples 11-26

The examples were prepared from blends using the materials described above and commercially available unsaturated polyester and vinyl ester resins from Reichhold, Inc. The results are listed in Tables 1, 2 and 3.

### Examples 27-32

Blends of a unsaturated polyester and the reactive (meth)acrylate intermediate were prepared and cured with and amine promoter, a cobalt salt and methyl ethyl ketone peroxide. The liquid resin was cured in a 50 ml graduated cylinder at room temperature. The samples were allowed to stay at room temperature for 24 hours and their volume expansion was measured. The results are summarized in Table 4.

TABLE 1
Physical Properties of Resin Blends.

| Properties | Unite | Ex. 11 | Ex. 12 | Ex. 13 | Ex. 14 | Ex. 15 | Ex. 16 | Ex. 17 |
|---|---|---|---|---|---|---|---|---|
| Example 6 | g | 200 | 175 | | | | | |
| Example 5 | g | | | 175 | 175 | | | |
| Example 3 | g | | | | | 150 | 167 | 172 |
| 31051-00 | g | | | | | | | 688 |
| 31453-00 | g | | 525 | | 525 | | | |
| 33375-00 | g | 800 | | 700 | | 600 | 668 | |
| Styrene | | 32 | 71 | 24 | 70 | 20 | | |
| α-methylstyrene | | | 27 | | 27 | | | |
| Barcol | | 40-46 | 41-49 | 50-55 | 48-52 | 60-65 | 40-44 | 38-41 |
| HDT | | 96.9 | 79.4 | 102 | 84.5 | 100 | 105.5 | 61 |
| Flex Max | psi | 22467.7 | 12687.9 | 23786.6 | 18512 | 24832 | 23891.9 | 17205.8 |
| Flex Mod | kpsi | 605.5 | 723.9 | 591.3 | 708.9 | 604.9 | 598.5 | 560.3 |
| Tens Max | psi | 11732.7 | 7384.8 | 12587.1 | 7811.4 | 12011.1 | 11478.3 | 7995.6 |
| Tens Mod | kpsi | 544.7 | 534.3 | 515.9 | 507.2 | 528.6 | 525 | 503.4 |
| Elongation | % | 2.8 | 1.6 | 3.3 | 1.7 | 3.0 | 2.7 | 1.8 |
| Comp Max | psi | 19525.9 | 20051.9 | 19385.8 | 19492.6 | 19605.2 | 19605.9 | 18520 |
| Comp Mod | kpsi | 414.8 | 405.3 | 372.5 | 356.1 | 381.3 | 378.5 | 367 |

TABLE 2
Physical Properties of Resin Blends.

| Properties | Unite | Ex. 8 | Ex. 18 | Ex. 19 | Ex. 20 | Ex. 21 | Ex. 22 | Ex. 23 | Ex. 24 | Ex. 1 |
|---|---|---|---|---|---|---|---|---|---|---|
| Example 1 | g | | | | | 700 | 200 | 175 | 175 | |
| Example 8 | g | | 200 | 175 | 400 | | | | | |
| 31051-00 | g | | | | | | | | 525 | |
| 31453-00 | g | | | 525 | 400 | | | 525 | | |
| 33375-00 | g | | 800 | | | | 800 | | | |
| Styrene | | | 32 | 71.8 | | 100 | 32 | 71.8 | 71.8 | |
| α-methylstyrene | | | | 27 | | | | 27 | 27 | |
| Barcol | | 41-44 | 39-46 | 36-41 | 39-44 | 59-64 | 64-71 | 69-74 | 64-69 | 66-69 |
| HDT | | 69.2 | 108.2 | 85.4 | 68.9 | 60.6 | 105.5 | 86.8 | 66.7 | 56.0 |
| Flex Max | psi | 16294 | 24155 | 13393.7 | 17059.9 | 19329 | 23306.7 | 15163.5 | 15977.4 | 17395.3 |
| Flex Mod | kpsi | 492.4 | 671.8 | 558.7 | 540.5 | 507.7 | 606.6 | 588.3 | 565 | 580.4 |
| Tens Max | psi | 9299 | 10940.4 | 86856.8 | 9614.9 | 10471.1 | 11799.8 | 7950.3 | 8722.9 | 8875.5 |
| Tens Mod | kpsi | 478.8 | 520.2 | 502.8 | 495.8 | 478.9 | 535.6 | 528.9 | 508 | 461.9 |
| Elongation | % | 2.5 | 2.6 | 1.9 | 2.3 | 3.1 | 2.9 | 1.8 | 2.0 | 2.6 |
| Comp Max | psi | 16509.6 | 19455.1 | 18850.5 | 18752.3 | 16708.4 | 19746.5 | 19536.4 | 19115 | 16130.4 |
| Comp Mod | kpsi | 344.4 | 378.4 | 371.7 | 373 | 352.3 | 385.9 | 385.9 | 357 | 339.9 |

TABLE 3
Physical Properties of Resin Blends.

| Properties | Unite | Ex. 9 | Ex. 10 | Ex. 25 | Ex. 25 | Ex. 26 |
|---|---|---|---|---|---|---|
| Example 9 | g | 1000 | | | | |
| Example 10 | g | | 1000 | 200 | 175 | 175 |
| 31051-00 | g | | | | 525 | |
| 31453-00 | g | | | | | 525 |
| 33375-00 | g | | | 800 | | |
| styrene | | | | 32 | 71.8 | 71.8 |
| α- | | | | | 27 | 27 |
| methylstyrene | | | | | | |
| Barcol | | 39-41 | 40-41 | 46-48 | 42-43 | 43-46 |
| HDT | | 54.6 | 54.9 | 104.6 | 68.6 | 81.7 |
| Flex Max | psi | 15531.5 | 16898.9 | 21622.8 | 15561.1 | 15130.9 |
| Flex Mod | kpsi | 451.6 | 445.2 | 584.6 | 545.9 | 570.7 |
| Tens Max | psi | 9822.2 | 10017.8 | 10433.4 | 8629.3 | 8120.2 |
| Tens Mod | kpsi | 506.9 | 495.8 | 556.2 | 509.9 | 531.4 |
| Elongation | % | 2.6 | 2.9 | 2.3 | 2.0 | 1.7 |
| Comp Max | psi | 18111.2 | 17354.2 | 20389.4 | 19532.0 | 19866.7 |
| Comp Mod | kpsi | 352.0 | 338.6 | 377.8 | 383.8 | 390.5 |

TABLE 4
Volume Expansion of Resin Blends.

| | #27 | #28 | #29 | #30 | #31 | #32 |
|---|---|---|---|---|---|---|
| | Amount | Amount | Amount | Amount | Amount | Amount |
| LPA* | 30 | 25 | 20 | 30 | 25 | 20 |
| Example 10 | 26.7 | 29 | 31.2 | 29.1 | 31.95 | 34.2 |
| 31025-00 | 40 | 40 | 40 | 40.9 | 40 | 40 |
| STY | 3.3 | 6 | 8.8 | 0 | 3.05 | 5.8 |
| Visc. Bkfl., | 220 | 210 | 190 | 210 | 205 | 200 |
| cps. | | | | | | |
| % Expansion** | 6.0 | 6.0 | 4.5 | 6.0 | 4.5 | 3.0 |

*Polyvinyl acetate dissolved in a 40% unsaturated monomer solution.
**% Volume Expansion measured with a volumetric cylinder.

That which is claimed is:

1. A laminating resin having low styrene content, said resin comprising:
a) a thermosetting resin; and
b) a reactive intermediate comprising a low molecular weight polyester oligomer endcapped with at least one (meth)acrylic acid, its ester or its anhydride thereof.

2. The laminating resin according to claim 1, wherein said reactive intermediate has a molecular weight range of 200 to 1500.

3. The laminating resin according to claim 1, wherein the reactive intermediate is formed by esterifying or trans-esterifying a saturated or unsaturated polyester with at least one polyhydric alcohol, and further esterifying or transesterifying the resulting product with at least one (meth)acrylic acid, its ester or an anhydride thereof.

4. The laminating resin according to claim 3, wherein the ratio of saturated or unsaturated polyester to polyhydric alcohol is a range of 1:1.2 to 1:1.5.

5. The laminating resin according to claim 3, wherein said saturated or unsaturated polyester is recycled polyethylene terephthalate and said polyhydric alcohol is diethylene glycol.

6. The laminating resin according to claim 1, wherein said thermosetting resin is selected from the group consisting of unsaturated polyester resins, saturated polyester resins, urethanes and vinyl esters.

7. The laminating resin according to claim 1, wherein the polyhydric alcohol is selected from the group consisting of ethylene glycol, diethylene glycol, propylene glycol, dipropylene glycol, 1,3-butanediol, 1,4-butanediol, 1,3-hexanediol, neopentyl glycol, 2-methyl-1,3-propanediol, 1,3-butylene glycol, 1,6-hexanediol, hydrogenated bisphenol A, cyclohexane dimethanol, 1,4-cyclohexanol, ethylene oxide adducts of bisphenols, propylene oxide adducts of bisphenols, sorbitol, 1,2,3,6-hexatetrol, 1,4-sorbitan, pentaerythritol, dipentaerythritol, tripentaerythritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene, and mixtures thereof.

8. The laminating resin according to claim 1, further comprising a polyfunctional acrylate monomer.

9. The laminating resin according to claim 1, further comprising a low profile additive.

10. The laminating resin according to claim 1, wherein said reactive intermediate has a viscosity of 150 to 250 cps.

11. A laminating resin devoid of styrene, said resin comprising:
a) a thermosetting resin selected from the group consisting of saturated and unsaturated polyesters, urethanes and vinyl esters, said thermosetting resin blended with;
b) a reactive intermediate comprising a polyester oligomer formed by (i) esterifying or trans-esterifying a saturated or unsaturated polyester with at least one polyhydric alcohol, wherein said polyester oligomer has a molecular weight range of 200 to 1500 and the ratio of polyester to polyhydric alcohol is a range of 1:1.2 to 1:1.5, and (ii) further esterifying or trans-esterifying with at least one (meth)acrylic acid, its ester or anhydride thereof.

12. The laminating resin according to claim 11, wherein said saturated or unsaturated polyester is recycled polyethylene terephthalate and said polyhydric alcohol is diethylene glycol.

13. The laminating resin according to claim 11, wherein the polyhydric alcohol is selected from the group consisting of ethylene glycol, diethylene glycol, propylene glycol, dipropylene glycol, 1,3-butanediol, 1,4-butanediol, 1,3-hexanediol, neopentyl glycol, 2-methyl-1,3-pentanediol, 1,3-butylene glycol, 1,6-hexanediol, hydrogenated bisphenol A, cyclohexane dimethanol, 1,4-cyclohexanol, ethylene oxide adducts of bisphenols, propylene oxide adducts of bisphenols, sorbitol, 1,2,3,6-hexatetrol, 1,4-sorbitan, pentaerythritol, dipentaerythritol, tripentaerythritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene, and mixtures thereof.

14. The laminating resin according to claim 11, further comprising a polyfunctional acrylate monomer.

15. The laminating resin according to claim 11, further comprising a low profile additive.

16. The laminating resin according to claim 11, wherein said reactive intermediate has a viscosity of 150 to 250 cps.

17. A laminating resin comprising:
1 to 99 percent by weight of a thermosetting resin;
1-99 percent by weight of a reactive intermediate comprising a low molecular weight polyester oligomer endcapped with at least one (meth)acrylic acid, its ester or its anhydride;
1-60 percent by weight of a filler;
0-40 percent by weight of a vinyl aromatic monomer;
0-40 percent by weight of a polyfunctional acrylate; and
0-50 percent by weight of a low profile additive.

18. The laminating resin according to claim 17, wherein the reactive intermediate is formed by esterifying or trans-esterifying a saturated or unsaturated polyester with at least one polyhydric alcohol, and further esterifying or transesterifying the resulting product with at least one (meth)acrylic acid, its ester or an anhydride thereof.

19. The laminating resin according to claim 18, wherein the ratio of saturated or unsaturated polyester to polyhydric alcohol is a range of 1:1.2 to 1:1.5.

20. The laminating resin according to claim 17, wherein said saturated or unsaturated polyester is recycled polyethylene terephthalate and said polyhydric alcohol is diethylene glycol.

21. The laminating resin according to claim 17, wherein said thermosetting resin is selected from the group consisting of unsaturated polyester resins, saturated polyester resins, urethanes and vinyl esters.

22. The laminating resin according to claim 17, wherein the polyhydric alcohol is selected from the group consisting of ethylene glycol, diethylene glycol, propylene glycol, dipropylene glycol, 1,3-butanediol, 1,4-butanediol, 1,3-hexanediol, neopentyl glycol, 2-methyl-1,3-propanediol, 1,3-butylene glycol, 1,6-hexanediol, hydrogenated bisphenol A, cyclohexane dimethanol, 1,4-cyclohexanol, ethylene oxide adducts of bisphenols, propylene oxide adducts of bisphenols, sorbitol, 1,2,3,6-hexatetrol, 1,4-sorbitan, pentaerythritol, dipentaerythritol, tripentaerythritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene, and mixtures thereof.
